(19) United States
(12) Patent Application Publication
(10) Pub. No.: US 2026/0075632 A1
(43) Pub. Date: Mar. 12, 2026

(54) RESOURCE SELECTION FOR SUBNETWORKS

(71) Applicant: Nokia Technologies Oy, Espoo (FI)

(72) Inventors: Dong LI, Shanghai (CN); Paolo BARACCA, Stuttgart (DE); Saeed Reza KHOSRAVIRAD, Mountainside, NJ (US); Tao TAO, Shanghai (CN)

(21) Appl. No.: 19/103,866

(22) PCT Filed: Aug. 15, 2022
(86) PCT No.: PCT/CN2022/112591

§ 371 Date: Feb. 14, 2025

(51) Int. Cl. H04W 72/541; H04W 72/02

(52) U.S. Cl. CPC H04W 72/541; H04W 72/02

(57) ABSTRACT

Example embodiments of the present disclosure relate to resource selection for subnetworks. A first device obtains status information associated with a first subnetwork of the radio access network. The first device determines, based at least on the status information from at least a first mode and a second mode, a resource selection mode for selecting a resource for communication within the first subnetwork. The first device transmits, to a second device in the first subnetwork, configuration information at least associated with the determined resource selection mode.

### FIELD

Various example embodiments of the present disclosure generally relate to the field of telecommunication and in particular, to methods, devices, apparatuses and computer readable storage medium for resource selection for subnetworks.

### BACKGROUND

An in-X subnetwork (which is referred to as a subnetwork hereafter) is a promising component to meet the extreme performance requirements in terms of latency, reliability and/or throughput envisioned for certain the sixth generation (6G) short-range scenarios. The subnetworks are generally installed in specific entities, e.g., in-vehicle, in-body, in-house, etc., to provide life-critical data service with extreme performances over the local capillary coverage. The use cases of in-robot subnetworks, in-production module subnetworks and in-vehicle subnetworks have extreme performance requirements in both reliability (up to 6 nines or more) and latency (down to the level of 100 us or even below) e.g., for the high demanding periodic deterministic communication services. These use cases may be the most challenging scenarios in 6G system.

### SUMMARY

In a first aspect of the present disclosure, there is provided a first device in a radio access network. The first device comprises at least one processor; and at least one memory storing instructions that, when executed by the at least one processor, cause the first device at least to perform: obtaining status information associated with a first subnetwork of the radio access network; determining, based at least on the status information from at least a first mode and a second mode, a resource selection mode for selecting a resource for communication within the first subnetwork; and transmitting, to a second device in the first subnetwork, configuration information at least associated with the determined resource selection mode.

In a second aspect of the present disclosure, there is provided a second device in a first subnetwork of a radio access network. The second device comprises at least one processor; and at least one memory storing instructions that, when executed by the at least one processor, cause the second device at least to perform: receiving, from a first device in the radio access network, configuration information associated with a resource selection mode for selecting a resource for communication within the first subnetwork, wherein the resource selection mode is at least one of a first mode and a second mode.

In a third aspect of the present disclosure, there is provided a third device in a second subnetwork. The third device comprises at least one processor; and at least one memory storing instructions that, when executed by the at least one processor, cause the third device at least to perform: receiving, from a second device in a first subnetwork of a radio access network, a second parameter associated with a second mode for selecting a resource for communication within the second subnetwork, wherein the second subnetwork is outside the radio access network; and selecting the resource for the communication within the second subnetwork based at least on the second parameter.

In a fourth aspect of the present disclosure, there is provided a method. The method comprises: obtaining, at a first device in a radio access network, status information associated with a first subnetwork of the radio access network; determining, based at least on the status information from at least a first mode and a second mode, a resource selection mode for selecting a resource for communication within the first subnetwork; and transmitting, to a second device in the first subnetwork, configuration information at least associated with the determined resource selection mode.

In a fifth aspect of the present disclosure, there is provided a method. The method comprises: receiving, at a second device in a first subnetwork of a radio access network and from a first device in the radio access network, configuration information associated with a resource selection mode for selecting a resource for communication within the first subnetwork, wherein the resource selection mode is at least one of a first mode and a second mode.

In a sixth aspect of the present disclosure, there is provided a method. The method comprises: receiving, at a third device in a second subnetwork and from a second device in a first subnetwork of a radio access network, a second parameter associated with a second mode for selecting a resource for communication within the second subnetwork, wherein the second subnetwork is outside the radio access network; and selecting the resource for the communication within the second subnetwork based at least on the second parameter.

In a seventh aspect of the present disclosure, there is provided a first apparatus in a radio access network. The first apparatus comprises: means for obtaining status information associated with a first subnetwork of the radio access network; means for determining, based at least on the status information from at least a first mode and a second mode, a resource selection mode for selecting a resource for communication within the first subnetwork; and means for transmitting, to a second apparatus in the first subnetwork, configuration information at least associated with the determined resource selection mode.

In an eighth aspect of the present disclosure, there is provided a second apparatus in a first subnetwork of a radio access network. The second apparatus comprises: means for receiving, from a first apparatus in the radio access network, configuration information associated with a resource selection mode for selecting a resource for communication within the first subnetwork, wherein the resource selection mode is at least one of a first mode and a second mode.

In a ninth aspect of the present disclosure, there is provided a third apparatus in a second subnetwork. The third apparatus comprises: means for receiving, at a third apparatus in a second subnetwork and from a second apparatus in a first subnetwork of a radio access network, a second parameter associated with a second mode for selecting a resource for communication within the second subnetwork, wherein the second subnetwork is outside the radio access network; and means for selecting the resource for the communication within the second subnetwork based at least on the second parameter.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for determining a resource selection mode according to some example embodiments of the present disclosure;

FIG. 3 illustrates an example of parameters associated with resource selection modes according to some example embodiments of the present disclosure;

FIG. 4 illustrates a signaling chart for selecting a resource in a distributed resource selection mode according to some example embodiments of the present disclosure;

FIG. 5 illustrates a signaling chart for selecting a resource in a centralized resource selection mode according to some example embodiments of the present disclosure;

FIG. 6A illustrates an example scenario according to some example embodiments of the present disclosure;

FIG. 6B illustrates example parameters for the example scenario of FIG. 6B according to some example embodiments of the present disclosure;

FIG. 7 illustrates a flowchart of a method implemented at a first device according to some example embodiments of the present disclosure;

FIG. 8 illustrates a flowchart of a method implemented at a second device according to some example embodiments of the present disclosure;

FIG. 9 illustrates a flowchart of a method implemented at a third device according to some example embodiments of the present disclosure;

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (JAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

### Example Environment

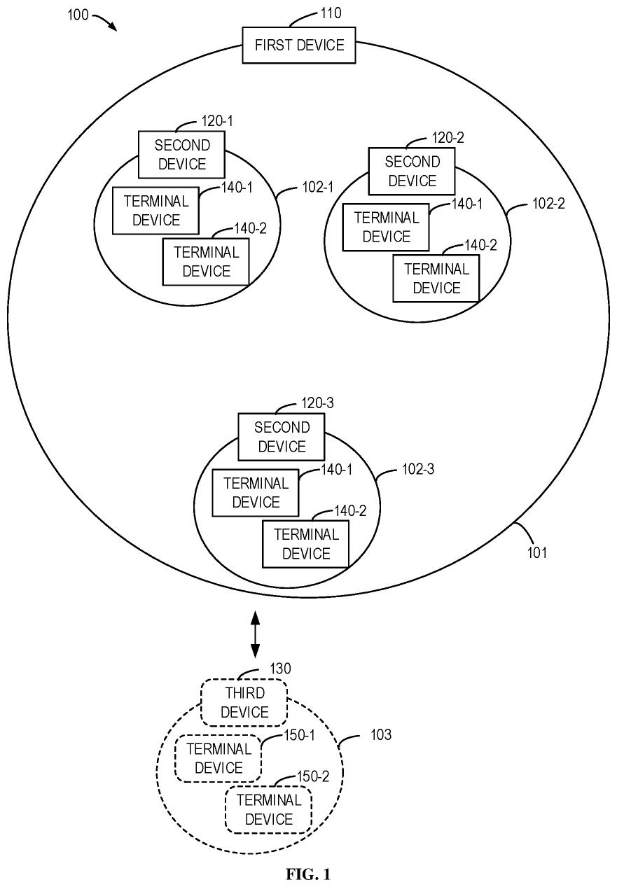

FIG. 1 illustrates an example communication environment 100 in which example embodiments of the present disclosure can be implemented. The communication environment 100 comprises a radio access network 101 (which is also referred to as network 101 hereinafter) and a first device 110 in the network 101. The network 101 may be a wide area network (WAN). The first device 110 may be a base station of the network 101.

A plurality of subnetworks 102-1, 102-2 and 102-3, which are collectively referred to as first subnetworks 102 or individually referred to as a first subnetwork 102, are located in the coverage of the network 101. The subnetworks 102-1, 102-2 and 102-3 comprise second devices 120-1, 120-2 and 120-3, respectively, which are collectively referred to as second devices 120 or individually referred to as a second device 120. Each subnetwork 102 may comprise a plurality of terminal devices 140-1 and 140-2, which are collectively referred to as terminal devices 140 or individually referred to as a terminal device 140.

The second device 120 may be a device which serves and manages the terminal devices 140 in the first subnetwork 102. The second device 120 may be connected to the first device 110 of the network 101, such that the first device 110 can control and coordinate the first subnetworks 102 to a certain extent. The second device 120 may comprise any suitable entities of the first subnetwork 102. In some example embodiments, the second device 120 may be an access point (AP) of the first subnetwork 102.

In some example embodiments, as shown in FIG. 1, the environment 100 may comprise a second subnetwork, which is located outside the coverage of the network 101. The second subnetwork 103 comprises a third device 130 and a plurality of terminal devices 150-1 and 150-2, which are collectively referred to as terminal devices 150 or individually referred to as a terminal device 150. The third device 130 may be a device which serves and manages the terminal devices 150 in the second subnetwork 103. The second subnetwork 103, for example the third device 130, can communicate with one or more first subnetwork 102.

The third device 130 may comprise any suitable entities of the second subnetwork 103. In some example embodiments, the third device 130 may be an AP of the second subnetwork 103.

The first subnetwork 102 and the optional second subnetwork 103 may be referred to as a subnetwork or subnetworks. The subnetworks in the environment 100 may comprise any suitable type of in-X subnetworks, including but not limited to, in-robot subnetworks, in-production module subnetworks, in-vehicle subnetworks, in-body subnetworks, and in-house subnetworks. It is to be understood that the number of subnetworks, second devices, terminal devices shown in FIG. 1 are only for the purpose of illustration without suggesting any limitation. The communication environment 100 may include any suitable number of devices configured to implementing example embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Communication within a first subnetwork (which is also referred to as “intra-subnetwork communication”) comprises at least one of communication between the second device 120 and the terminal device 140 or communication between the terminal device 140-1 and the terminal device 140-2. In some example embodiments, subband channelization may be used for the intra-subnetwork communication. That is, the carrier bandwidth is divided into multiple subband and each subnetwork operates in one or more subband.

A resource selection mode (RSM) is a mode for selecting a resource for communication within the first subnetwork 102. To operate efficiently, the resource selection mode is needed for the first subnetwork 102.

As mentioned above, the in-X subnetwork is a promising component in the 6G system. The subnetworks have specific properties, for example, extreme performance requirements in terms of latency, reliability and/or throughputs, low transmit power which implies a limited coverage (e.g., in the order of few meters); star or tree topology with one in-X AP and one or more in-X UEs under AP's control; overall mobility of AP and associated UEs, but lack/limited mobility across different subnetworks; a part of an overlay WAN, but must continue to work when out of a coverage if the WAN. The system design for the in-X subnetwork shall take the above properties into account.

Given the extreme performance requirements especially in latency and reliability, it is important to design an effective resource selection procedure for the subnetworks to adapt the subnetworks to the temporal and spatial interference situation variations to keep the inter-subnetwork interference as low as possible.

To achieve the extreme performance, on one hand the in-X subnetworks shall be designed to make full use of all potential diversity gains, e.g., frequency diversity, spatial diversity, in certain conditions time diversity, etc. On the other hand, the subnetworks shall operate over suitable (time/frequency) resources. Such suitable resources may satisfy some criteria. For example, the resources can be reused by the subnetworks that have little cross-interference to improve resource efficiency. For another example, with the resources, the inter-subnetwork interference level is kept sufficiently low for extreme reliability. For a further example, configurations of the resources shall be able to adapt to the variations in interference situations (e.g., due to the mobility of the subnetworks) to keep the interference at a low level constantly.

Moreover, there are various possible subnetwork scenarios and conditions. For example, some subnetworks are moving at a relatively high velocity, while some subnetworks are more static or quasi-static. Some subnetworks are under the coverage of the WAN and thus have connections to the BS of the WAN to enjoy the control or coordination from the WAN, while some subnetworks may be out of the coverage of the WAN. Despite of all these different scenarios or conditions, extreme performance requirements are applicable for all these subnetworks. Different resource selection modes are needed to support the various possible subnetwork scenarios and conditions.

In view of the above, a mechanism for resource selection for subnetworks are needed to fulfil the extreme performance requirements of the subnetworks.

### Work Principle and Example Signaling for Communication

According to some example embodiments of the present disclosure, there is provided a solution for resource selection for subnetworks. In this solution, a first device in a radio access network obtains status information associated with a first subnetwork of the radio access network. The first device determines, based at least on the status information and from at least a first mode and a second mode, a resource selection mode for selecting a resource for communication within the first subnetwork. The first device transmits, to a second device in the first subnetwork, configuration information at least associated with the determined resource selection mode.

In this way, different subnetworks can operate in respective suitable resource selection modes. Different resource selection modes can coexist harmoniously in the radio access network so as to support subnetworks of various statuses. Such an effective resource selection mechanism can be adapted to the temporal and spatial interference variations among subnetworks, which is beneficial for meeting the extreme performance requirements for the subnetworks.

Example embodiments of the present disclosure will be described in detail below with reference to FIG. 1. In general, the resource selection mode supported in the environment 100 comprises at least a first mode and a second mode different from the first mode.

In some example embodiments, the first device 110 selects the resource for communication within a first subnetwork 102 if the first mode is determined as the resource selection mode for the first subnetwork 102. For purpose of discussion without any limitation, the first mode is also referred to as a centralized resource selection (CRS) mode. In other words, the resource is allocated by the first device 110 for a first subnetwork 102 in the CRS mode. The first mode and the CRS mode are used interchangeably herein.

The second device 120 in a first subnetwork 102 selects the resource for communication within the first subnetwork 102 if the second mode is determined as the resource selection mode for the first subnetwork 102. For purpose of discussion without any limitation, the second mode is also referred to as a distributed resource selection (DRS) mode. In other words, the resource is selected by the second device 120 of a first subnetwork 102 in the DRS mode. The second mode and the DRS mode are used interchangeably herein.

On one hand, the properties of the subnetworks as mentioned above allow the CRS mode for the subnetworks to achieve extreme performances. On the other hand, some subnetworks may be moving at a relatively large velocity or be located outside the radio access network 101, which means that the DRS mode shall also be supported. There is a performance gap between the CRS mode and the DRS mode. Given that, to achieve the extreme performances for the subnetworks, the CRS mode may be applied if possible.

Meanwhile, the DRS mode may be optimized to support the subnetworks for which the CRS mode is not suitable. Therefore, a suitable resource selection mode is determined for a specific subnetwork.

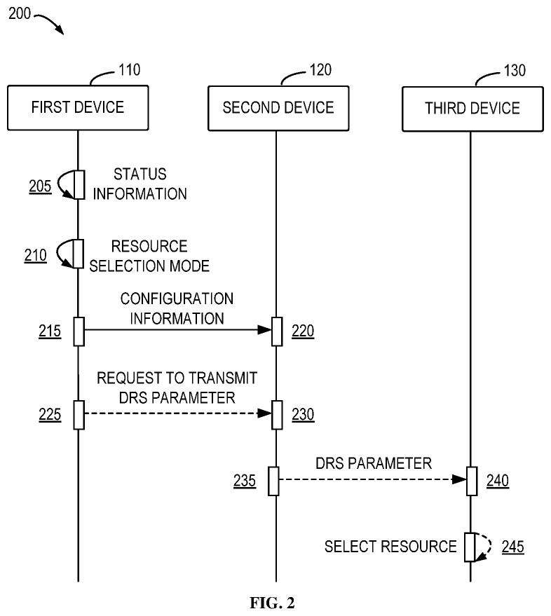

FIG. 2 shows a signaling chart 200 for determining a resource selection mode according to some example embodiments of the present disclosure. As shown in FIG. 2, the signaling chart 200 involves a first device 110 and a second device 120. In some example embodiments, the signaling chart 200 further involves a third device 130. For the purpose of discussion, reference is made to FIG. 1 to describe the signaling chart 200. Although one second device 120 and one third device 130 are illustrated in FIG. 2, it would be appreciated that there may be a plurality of second device performing similar operations as described with respect to the second device 120 below and a plurality of third device performing similar operations as described with respect to the third device 130 below.

At 205, the first device 110 obtains status information associated with the first subnetwork 102. The status information may be obtained in any suitable manner, for example based on relevant information available at the first device 110. In some example embodiments, the status information may be received from the second device 120 of the first subnetwork 102. For example, the second device 120-1 may transmit the status information associated with the first subnetwork 102-1 to the first device 110. Alternatively, or in addition, the status information may be obtained by the first device 110 from a source different from the second device 120. For example, in an industrial scenario, a digital twin (DT) of all robots and machines may be available, and this DT may be connected to the network 101 and provide such information to the first device 110.

The status information may indicate a mobility status or a communication status of the first subnetwork 102. In some example embodiments, the status information may indicate a channel quality of the first subnetwork 102. The channel quality may be a subnetwork channel quality (SCQ) of the first subnetwork 102. The SCQ of a subnetwork refers to a consolidated channel quality for all the transmission links within the subnetwork over a resource (e.g., a subband) in use. For example, the SCQ may include an average or minimum of Signal to Interference plus Noise Ratios (SINRs) of all the transmission links.

Alternatively, or in addition, in some example embodiments, the status information may indicate an interference level sensed within the first subnetwork 102. The interference level may be a subnetwork aggregated interference (SAI) of the first subnetwork 102. The SAI of a subnetwork refers to the sum of all the potential interference from all the other subnetworks over each of the subbands.

Alternatively, or in addition, in some example embodiments, the status information may indicate a mobility status associated with the first subnetwork 102. In an example, the status information may include an indication of whether the first subnetwork 102 is at a fast moving status or not. For example, for a first subnetwork associated with a moving vehicle, or a mobile robot, the status information may indicate a fast moving status. For a first subnetwork associated with a pedestrian or a vehicle in traffic jam, the status information may indicate a non-fast moving status. In another example, the status information may include an indication of the moving speed of the first subnetwork 102. Based on the moving speed, whether the first subnetwork 102 is at a fast moving status can be determined.

In addition, in some example embodiments, the second device 120 may indicate to the first device 110 of its preference for the resource selection mode. For example, the second device 120 may indicate to the first device 110 that the CRS mode or the DRS mode is preferred in the first subnetwork 102.

Obtaining the status information may be performed periodically. For example, the first device 110 may periodically receive the status information from the second device 120 or another source.

Alternatively, or in addition, obtaining the status information may be responsive to activating the determination of the resource selection mode. Before obtaining the status information at 205, all the first subnetworks 102 in the network 101 may be operating in a default mode. The first device 110 may activate another mode based on a trigger event and notifies the first subnetworks 102. The second device 120 may feedback the status information to the first device 110 in response to the activation. For example, before obtaining the status information at 205, all the first subnetworks 102 are operating in the DRS mode, which means that all the first subnetworks 102 autonomously select the resource based on local channel measurements and the relevant parameter/resource (pre-)configurations. The first device 110 may activate the CRS mode based on performance degradation of some first subnetworks 102 and notifies the first subnetworks 102 of the activation of the CRS mode. The second device 120 may feedback the status information to the first device 110 in response to the activation of the CRS mode.

Continuing with FIG. 2, at 210, the first device 110 determines, based on the status information and from at least the first mode and the second mode, a resource selection mode for the first subnetwork 102. The resource selection mode determined for the first subnetwork 102 may depend on at least one of the mobility status of the first subnetwork 102 or a communication quality of the first subnetwork 102. The communication quality may include at least one of the channel quality of the first subnetwork 102 or the interference level sensed within the first subnetwork 102.

In some example embodiments, if the communication quality of the first subnetwork 102 is below a threshold and the mobility status indicates a non-fast moving status, the first device 110 may determine the first mode as the RSM for the first subnetwork 102.

Otherwise, the first device 110 may determine the second mode as the RSM for the first subnetwork 102.

Specifically, for a specific first subnetwork 102, if the mobility status indicates a fast moving status, the DRS mode is determined as the RSM for the first subnetwork 102.

Alternatively, or in addition, if the channel quality exceeds a first threshold (for example, SCQ exceed threshold 1) and/or the interference level sensed within the first subnetwork 102 is less than a second threshold (for example, SAI is less than threshold 2), the DRS mode is determined as the RSM for the first subnetwork 102.

If the mobility status indicates a non-fast moving status and the channel quality does not exceeds the first threshold (for example, SCQ is less than or equal to threshold 1), the CRS mode is determined as the RSM for the first subnetwork 102. If the mobility status indicates a non-fast moving status and the interference level is above the second threshold (for example, SAI is larger than or equal to threshold 2), the CRS mode is determined as the RSM for the first subnetwork 102. If the mobility status indicates a non-fast moving status, the channel quality does not exceed the first threshold (for example, SCQ is less than or equal to threshold 1) and the interference level is above the second threshold (for example, SAI is larger than or equal to threshold 2), the CRS mode is determined as the RSM for the first subnetwork 102.

By determining the RSM based on the status information associated with a subnetwork, the subnetworks can be adapted to the temporal and spatial interference variations to offer the extreme performances. In the following, a first subnetwork 102 for which the first mode or the CRS mode is determined as the RSM is also referred to as a CRS subnetwork. A first subnetwork 102 for which the second mode or the DRS mode is determined as the RSM is also referred to as a DRS subnetwork.

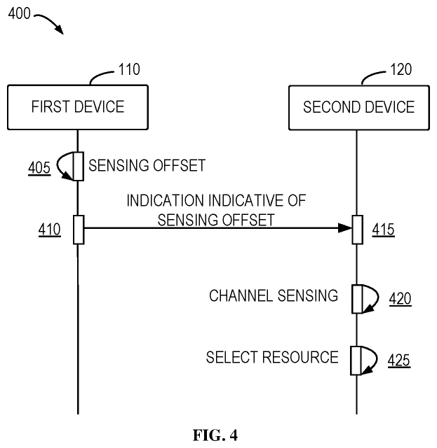

The first device 110 may transmit an indication indicative of the determined RSM to the second device 120. The indication may be transmitted to the second device 120 in a dedicated signaling along with other information. For example, if the first mode is determined as the RSM for the first subnetwork 102, the indication may be transmitted along with measurement configuration information associated with an interference measurement, as will be described with reference to FIG. 5. If the second mode is determined as the RSM for the first subnetwork 102, the indication may be transmitted along with another indication of a sensing offset, as will be described with reference to FIG. 4.

Continuing with FIG. 2, at 215, the first device 110 transmits to the second device 120 configuration information at least associated with the determined RSM. The configuration information may be further associated with another mode. For example, if the first mode is determined as the RSM for the first subnetwork 102, the configuration information is at least associated with the first mode. The configuration information may be further associated with the second mode.

In some example embodiments, the configuration information may comprise a first parameter associated with the first mode. The first parameter is also referred to as a CRS parameter for purpose of discussion without any limitation. The CRS parameter may comprise at least one of: a duration of a first period associated with the first mode, or a starting offset indicative of when the first period starts.

The first period is a period during which the first device 110 selects the resource for the communication within the first subnetwork 102 and is also referred to as a CRS period. The duration of the CRS period may be represented by any suitable time unit, e.g., in the unit of transmission (TX) cycles. The duration of the CRS period may be set to a relatively large value. For example, the duration of the CRS period may be set to be 1000 TX cycles, which corresponds to 100 ms in the case of 100ρs TX cycle duration.

The starting offset indicative of when the first period starts is also referred to as a CRS offset. The CRS offset corresponds to a time instant or a TX cycle when the first subnetwork 102 in the CRS mode starts using the resource for the intra-subnetwork communication according to the latest resource allocation by the first device 110. In an example, the CRS offset may be represented by a TX cycle, which satisfies the criterion “TX cycle index modulo CRS period=CRS offset”.

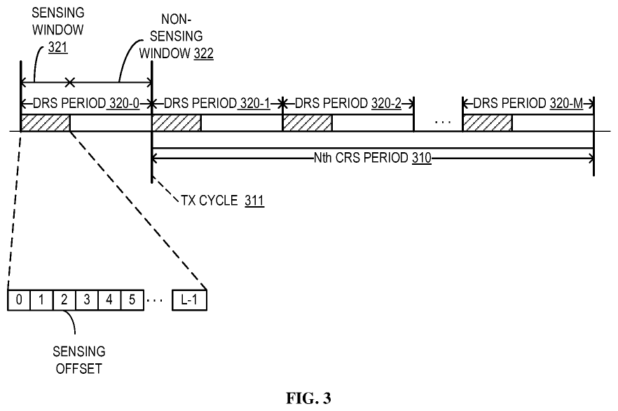

FIG. 3 illustrates an example of parameters associated with resource selection modes according to some example embodiments of the present disclosure. FIG. 3 shows the Nth CRS period 310, which starts from the TX cycle 311. The TX cycle 311 satisfies the criterion “TX cycle index modulo CRS period=CRS offset”. This means that the first subnetwork 102 in the CRS mode starts using the resource latest allocated by the first device 110 for the intra-subnetwork communication.

In some example embodiments, the configuration information may comprise a second parameter associated with the second mode. The second parameter is also referred to as a DRS parameter for purpose of discussion without any limitation. The DRS parameter may comprise at least one of: a duration of a second period associated with the second mode, or a duration of a sensing window within the second period.

The second period is a period during which the second device 120 selects the resource for the communication within the first subnetwork 102 based on a channel sensing and is also referred to as a DRS period. The duration of the DRS period may be represented in any suitable time unit, e.g., in the unit of TX cycles. The DRS period may be shorter than the CRS period. In some example embodiment, the duration of the CRS period may be an integer multiple of the duration of the DRS period. For example, in the case where the duration of the CRS period comprises 1000 TX cycles, the duration of the DRS period may comprise 100 TX cycle. This is beneficial for the harmonious coexistence of subnetworks in the DRS mode and subnetworks in the CRS mode.

The sensing window within the second period is a time period during which the channel sensing is performed. The duration of the sensing window may be represented by the unit of TX cycles. The sensing window may start from the TX cycle, which satisfies the criterion “TX cycle index modulo DRS period=CRS offset modulo DRS period”.

FIG. 3 shows a plurality of DRS periods 320-0, 320-2, 320-2, 320-3 . . . 320-M, which are collectively referred to as DRS periods 320 or individually referred to as a DRS period 320, where M is a positive integer. As can be seen, the CRS period 310 corresponds to more than one DRS periods 320. Each DRS period 320 may comprise a sensing window 321 and a non-sensing window 322. During the non-sensing window 322, no subnetwork performs channel sensing. As shown in FIG. 3, the sensing window is aligned with the beginning of the CRS period, which alleviates cross-interference between CRS subnetworks and proximate DRS subnetworks.

Reference is made back to FIG. 2. In some example embodiments, the first device 110 may transmit the configuration information including the CRS parameter and the DRS parameter to the second device 120 in a in groupcast or broadcast manner, e.g., via a common RRC signaling, so that the first subnetworks 102 either in the CRS mode or in the DRS mode obtain the CRS parameter and the DRS parameter. For example, the CRS parameter and the DRS parameter may be transmitted via a common radio resource control (RRC) signaling.

Alternatively, in some example embodiments, the first device 110 may transmit the CRS parameter and the DRS parameter via dedicated signaling to a second device 120 of a CRS subnetwork and a DRS subnetwork, respectively. For example, if the CRS mode is determined as the RSM for the first subnetwork 102-1, the first device 110 may transmit the CRS parameter to the second device 120-1 via a dedicated signaling. If the DRS mode is determined as the RSM for the first subnetwork 102-3, the first device 110 may transmit the DRS parameter to the second device 120-3 via a dedicated signaling.

In some example embodiments, the DRS parameter or the CRS parameter may be transmitted along with other information. For example, the CRS parameter may be transmitted along with measurement configuration information associated with an interference measurement, as will be described with reference to FIG. 5. The DRS parameter may be transmitted along with the indication indicative of a sensing offset, as will be described with reference to FIG. 4.

It is to be understood that the determination of the DRS parameter and CRS parameter may occur before the step 210 or after the step 210. Example embodiments of the present disclosure are not limited in this regard. For example, if the determination of the parameters depends on the result of the step 210, the parameters are determined following the step 210. Otherwise, the parameters can be determined before the step 210.

Continuing with FIG. 2, at 220, the second device 120 receives from the first device 110 the configuration information at least associated with the determined RSM.

Accordingly, the first subnetwork 102 operates in the determined RSM. Depending on the statuses of the first subnetworks 102, various scenarios may occur. For example, in some example scenarios, all the first subnetworks 102 operate in the DRS mode. Alternatively, in some other example scenarios, all the first subnetworks 102 operate in the CRS mode. Alternatively, in some further example scenarios, one or more of the first subnetworks 102 operate in the CRS mode, and others of the first subnetworks 102 operate in the DRS mode.

In this way, harmonious coexistence of the subnetworks operating in different modes can be achieved. Moreover, by determining the RSM based on the status information associated with a subnetwork, the subnetworks can be adapted to the temporal and spatial interference variations to offer the extreme performances.

### Example Operations for Distributed Resource Selection Mode

Some example embodiments regarding the first subnetworks 102 operating in the DRS mode are now described. FIG. 4 illustrates a signaling chart 400 for selecting a resource in the DRS mode according to some example embodiments of the present disclosure. The signaling chart 400 involves the first device 110 and a second device 120 in a DRS subnetwork 102. For example, if the DRS mode is determined as the RSM for the first subnetwork 102-3, the signaling chart 400 involves the second device 120-3. Although one second device 120 is illustrated in FIG. 4, it would be appreciated that there may be a plurality of second devices performing similar operations as described with respect to the second device 120 below.

At 405, for the DRS subnetwork, the first device 110 determines a sensing offset within the sensing window based at least on the status information. The sensing offset indicates a starting time when the channel sensing is performed within the sensing window. Reference is now made to FIG. 3. As shown in FIG. 3, the sensing window 321 includes L sensing offsets, where L is a positive integer. The length of the sensing offset may be represented in any suitable time unit, for example, in the unit of TX cycles. In an example, each sensing offset may include one or more TX cycles, such as 3 TX cycles.

In some example embodiments, the first device 110 may determine the sensing offsets for different DRS subnetworks based on the status information associated with respective DRS subnetworks, such that a DRS subnetwork with a lower communication quality (for example, a lower SCQ or a larger SAI) is allocated with a smaller sensing offset. For example, if the DRS mode is determined as the RSM for the first subnetworks 102-2 and 102-3 and the first subnetwork 102-2 has a lower SCQ or a larger SAI than the first subnetwork 102-3, the sensing offset allocated to the first subnetwork 102-2 is smaller than the sensing offset allocated to the first subnetwork 102-3. In such example embodiments, the DRS subnetwork with a lower communication quality can have a higher priority in resource selection. In such example embodiments, cross-interference between the CRS subnetworks and the proximate DRS subnetworks can be alleviated.

In some example embodiments, the first device 110 may determine the sensing offsets based on positions of different DRS subnetworks, such that proximate DRS subnetworks are allocated with different sensing offsets. For example, if the distance between two DRS subnetworks is below a threshold distance, these two DRS subnetworks are allocated with different sensing offsets. Information associated with the positions of the DRS subnetworks may be fed back by the second device 120 for example in the status information or obtained by the first device 110 in any suitable way. In such example embodiments, by configuring different sensing offsets to the different proximate subnetworks, the potential cross-interference between different DRS subnetworks in the coverage of the overlay WAN is kept as low as possible.

Reference is made back to FIG. 4. At 410, the first device 110 transmits an indication indicative of the sensing offset to the second device 120. The indication may be transmitted to the second device 120 via physical control channel (PDCCH), or a medium access control (MAC) control element (CE) signaling, or a dedicated RRC signaling. As mentioned above, in some example embodiments, the DRS parameter or the indication indicative of the determined RSM may be transmitted together with the indication indicative of the sensing offset.

At 415, the second device 120 receives the indication indicative of the sensing offset. At 420, the second device 120 causes the channel sensing to be performed within the DRS subnetwork based on the sensing offset and the sensing window. For example, if the first subnetwork 102-3 is allocated with the 3^{rd} sensing offset of the sensing window 321, the channel sensing is performed at one or more TX cycles corresponding to the 3^{rd} sensing offset of the sensing window in each DRS period 320.

In some example embodiments, the second device 120 may perform the channel sensing based on the sensing offset and the sensing window. Alternatively, or in addition, the second device 120 may request a terminal device 140 in the DRS subnetwork to perform the channel sensing based on the sensing offset and the sensing window. The terminal device 140 may feedback a result of the channel sensing to the second device 120.

At 425, the second device 120 selects the resource (for example, one or more subbands) for the communication within the DRS subnetwork based on the channel sensing. Then, the DRS subnetwork may switch to the selected resource and use the selected resource for intra-subnetwork communication. In some example embodiments, the DRS subnetwork may start using the selected resource for intra-subnetwork communication from a sensing offset immediately subsequent to the sensing offset allocated by the first device 110. In this way, the possibility for another DRS subnetwork to select the same resource is reduced, which is beneficial for the extreme performance.

### Example Operations for Centralized Resource Selection Mode

Some example embodiments regarding the first subnetworks 102 operating in the CRS mode are now described. FIG. 5 illustrates a signaling chart 500 for selecting a resource in the CRS mode according to some example embodiments of the present disclosure. The signaling chart 500 involves the first device 110 and a second device 120 in a CRS subnetwork 102. For example, if the CRS mode is determined as the RSM for the first subnetwork 102-1, the signaling chart 500 involves the second device 120-1. Although one second device 120 is illustrated in FIG. 5, it would be appreciated that there may be a plurality of second device performing similar operations as described with respect to the second device 120 below.

At 505, the first device 110 transmits to the second device 120 measurement configuration information associated with an interference measurement performed within the CRS subnetwork. The measurement configuration information may indicate a reference signal for the interference measurement, measurement and reporting configuration, and so on. As mentioned above, in some example embodiments, the indication indicative of the determined RSM or the CRS parameter may be transmitted together with the measurement configuration information associated with the interference measurement.

At 510, the second device 120 receives from the first device 110 the measurement configuration information associated with the interference measurement. At 515, the interference measurement is performed within the CRS subnetwork based on the measurement configuration information. In some example embodiments, the second device 120 may perform the interference measurement based on the measurement configuration information. Alternatively, in addition, in some example embodiments, the second device 120 may request a terminal device 140 in the CRS subnetwork to perform the interference measurement based on the measurement configuration information.

At 520, the second device 120 transmits a measurement report associated with the interference measurement to the first device 110. The measurement report is indicative of interferences sensed within the CRS subnetwork. In some example embodiments, the measurement report may be indicative of an interference from a first subnetwork operating in the CRS mode. For example, such an interference may be per-subnetwork interference from other CRS subnetworks. Alternatively, or in addition, in some example embodiments, the measurement report may be indicative of an interference over a frequency subband. The interference over the frequency band includes interference from other DRS subnetworks but does not include the interference from other CRS subnetworks.

By including such interferences in the measurement report, the interference to/from the DRS subnetworks can be taken into account in the centralized resource selection. This is beneficial for alleviating potential cross-interference between the CRS subnetworks and the DRS subnetworks.

At 525, the first device 110 receives, from the second device 120, the measurement report associated with the interference measurement. At 530, the first device 110 selects the resource for the communication within the CRS subnetwork based at least on the measurement report. For example, the first device 110 may select one or more subbands for the CRS subnetwork by using a CRS algorithm.

At 535, the first device 110 transmits, to the second device 120, an indication indicative of the selected resource. For example, the indication may be indicative of the one or more subbands selected for the CRS subnetwork. At 540, the second device 120 receives the indication indicative of the selected resource from the first device 110.

In some example embodiments, the steps 505, 510, 515, 520, 525, 530 535 and 540 may be performed during a non-sensing window of the last DRS period within a CRS period. For example, these steps may be performed during the non-sensing window 322 of the DRS period 320-0, which is the last DRS periods within the (N−1)th CRS period. Dividing the DRS period into the sensing window and non-sensing window and performing the operations associated with the CRS mode within the non-sensing window is beneficial for interference control. This facilitates to keep the cross-interference between the CRS subnetworks and DRS subnetworks as low as possible.

At 545, the second device 120 performs the communication within the CRS subnetwork using the selected resource in the CRS period starting from the starting offset. For example, the second device 120 performs the intra-subnetwork communication using the subband allocated by the first device 110 in the Nth CRS period 310 from the TX cycle 311.

### Example Operations for Subnetworks Outside Radio Access Network

Due to the complexity of the subnetwork scenarios, there may be one or more subnetworks out of the coverage (OoC) of the radio access network, which is also referred to as an OoC subnetwork. For example, in the example of FIG. 1, the second subnetwork 103 is located outside the network 101. Reference is now made back to FIG. 2. Some example embodiments regarding the RSM of the OoC subnetwork are now described with reference to FIG. 1 and FIG. 2.

At 225, the first device 110 may transmit to the second device 120 a request to transmit the DRS parameter to the third device 130 in the second subnetwork 103 outside the network 101. In some example embodiments, the request may be an explicit indication transmitted via a dedicated signaling. The explicit indication may be transmitted via a separate signaling, or along with the configuration information transmitted at 215, or along with the indication transmitted at 410 for the DRS subnetwork, or along with the measurement configuration information transmitted at 505 for the CRS subnetwork.

Alternatively, or in addition, the request may be an implicit indication, for example, by configuring a cell edge threshold for reference signal received power (RSRP) measurement of the second device 120. In some example embodiments, the request further indicates the second device 120 to transmit the sensing offset determined for the DRS subnetwork 102 to the third device 130.

In some example embodiments, the second device 120 which is requested by the first device 110 to transmit the DRS parameter may be located in a first subnetwork 102 located at or proximate the edge of the network 101. For example, the first device 110 may determine that the first subnetwork 102-3 is proximate the edge of the network 101 based on the position of the first subnetwork 102-3 or the strength of the link between the first device 110 and the second device 120-3. Accordingly, the first device 110 may request the second device 120-3 to transmit the DRS parameter to the third device 130 of the second subnetwork 103.

At 230, the second device 120 may receive from the first device 110 the request to transmit the DRS parameter to the third device 130. In response to the request, at 235, the second device 120 may transmit the DRS parameter to the third device 130. For example, the second device 120 may broadcast the DRS parameter in a channel similar to a physical broadcast channel (PBCH). In some example embodiments, the second device 120 may further transmit the sensing offset determined for the DRS subnetwork 102 to the third device 130.

At 240, the third device 130 may receive the DRS parameter from the second device 120. In some example embodiments, the third device 130 may further receive the sensing offset determined for the DRS subnetwork 102 from the second device 120. At 245, the third device 130 may select a resource for communication within the second subnetwork 103 based at least on the DRS parameter. In this way, the DRS parameter for the OoC subnetworks and their operations are aligned with those in the coverage of the network 101.

In some example embodiments, the third device 130 may determine a sensing offset for the second subnetwork 103 based at least on the DRS parameter from the second device 120. In an example, the third device 130 may determine the sensing offset for the second subnetwork 103 randomly within the sensing window. In another example, the third device 130 may determine the sensing offset for the second subnetwork 103 based on a communication quality of the second subnetwork 103, such as the SCQ of the second subnetwork 103 or the SAI sensed within the second subnetwork 103.

The channel sensing may be performed within the second subnetwork 103 based on the sensing window and the sensing offset. In some example embodiments, the third device 130 may perform the channel sensing based on the sensing window and the sensing offset. Alternatively, or in addition, the third device 130 may request a terminal device 150 in the second subnetwork 103 to perform the channel sensing based on the sensing window and the sensing offset. Based on the channel sensing, the third device 130 may select the resource for the communication within the second subnetwork 103. For example, the third device 130 may select one or more subbands for the intra-subnetwork communication.

Then, the second subnetwork 103 may switch to the selected resource and use the selected resource for intra-subnetwork communication. In some example embodiments, the second subnetwork 103 may start using the selected resource for intra-subnetwork communication from a sensing offset immediately subsequent to the sensing offset determined by the third device 130.

In such example embodiments, by transmitting the DRS parameter to the out-of-coverage DRS subnetwork, collisions between in-coverage DRS subnetworks and out-of-coverage DRS subnetworks can be avoided as much as possible. This facilitates to keep the potential cross-interference between the in-coverage DRS subnetworks and the out-of-coverage DRS subnetworks as low as possible.

### Example Scenario

As can be seen from the above descriptions, some example embodiments provide an an effective resource selection framework to enable the subnetworks, whether or not in the coverage of the WAN, to adapt to the temporal and spatial interference variations to offer the extreme performances (e.g., 7 nines or more in low latency down to 100 us). The framework enables organic integration and harmonious coexistence of the subnetworks operating in CRS mode and the subnetworks in DRS mode.

Moreover, in the framework, the CRS is performed as much as possible to offer extreme performances, meanwhile for subnetworks that have to perform the distributed resource selection (e.g. those out of coverage of the WAN), the performance is also optimized by mitigating various potential interference as mentioned above. The subnetworks that are not suffering much interference are selected to operate in DRS mode, which allows saving energy and signaling overhead at these subnetworks, as these subnetworks can communication less frequently with the base station of the WAN (that is typically far away) and may require high transmission power.

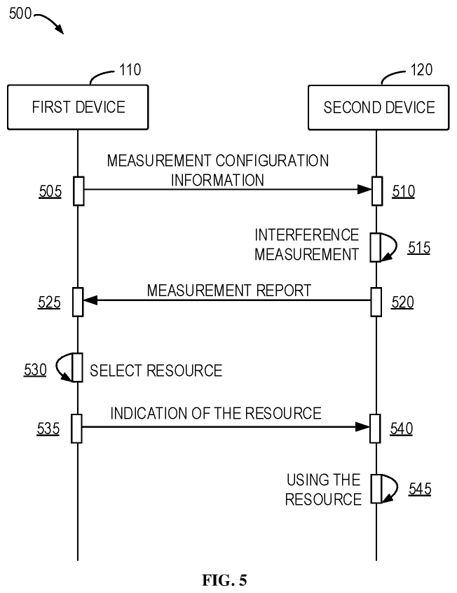

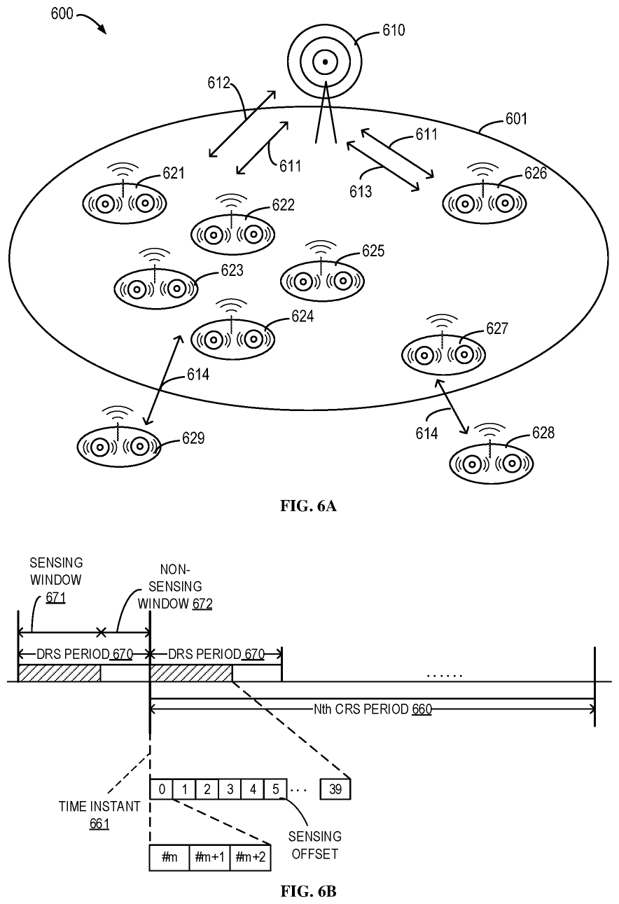

To better understand the example embodiments of the present disclosure, an example scenario is described with reference to FIG. 6A and FIG. 6B. It is to be understood that the number of subnetworks, parameters, devices are given for the purpose of illustration without any limitation. FIG. 6A illustrates an example scenario 600 according to some example embodiments of the present disclosure.

As shown in FIG. 6A, the example scenario 600 comprises subnetworks 621, 622, 623, 624, 625, 626, 627 in the radio access network 601. Among these subnetworks, the subnetworks 621, 622, 623, 624, 625 are proximate to each other. The local high subnetwork density in this area means that there may be potential large interference among these subnetworks if the resource selection for intra-subnetwork communication is not performed well. It is assumed that one or more of these subnetworks 621, 622, 623, 624, 625 report the critical situations to the BS 610 of the radio access network 601. The BS 610 further triggers the activation of CRS. Through the transmission links 611, the BS 610 indicates the activation of the CRS to APs of the subnetworks 621, 622, 623, 624, 625, 626, 627. The APs then feedback the measurements of SCQ and/or the SAI, together with the mobility status to the BS 610. Here it is assumed that the subnetworks 621, 622, 623, 624, 626, 627 are quasi-static while the subnetwork 625 is moving fast.

Based on the feedback from the subnetworks 621, 622, 623, 624, 625, 626, 627, the BS 610 determines that the subnetworks 621, 622, 623, 624 operate in the CRS mode, since they (potentially) suffer severe interference and at the same time they are in the non-fast-moving status. The BS 610 determines that the subnetworks 625, 626, 627 operate in the DRS mode, since the subnetwork 625 is in the fast-moving status and the subnetworks 626, 627 suffer little interference). Then, the BS 610 may determine the CRS parameter and DRS parameter and broadcast or groupcast the CRS parameter and DRS parameter to all the subnetworks via the transmission links 611.

The BS 610 may allocate sensing offsets to the subnetworks 625, 626, 627, which are the subnetworks in the DRS mode in the network 601. In particular, the subnetwork 625 is allocated with a very small sensing offset e.g., sensing offset 0, since the subnetwork 625 may have severe cross-interference with the subnetworks 621, 622, 623, 624. Meanwhile, the subnetworks 626 and 627 may be allocated with relatively large sensing offsets, since they are rather isolated and have little impact on other subnetworks. The allocated sensing offsets are conveyed to the subnetworks via the transmission links 613 as shown in FIG. 6A. Some subnetworks, especially those on the edge of the network 601 (e.g., the subnetworks 623, 624, 627), may broadcast the DRS parameter and/or the allocated sensing offset via the transmission links 614, so that the subnetworks 628 and 629 which are out of the coverage of the network 601 can acquire these parameters.

For the subnetworks in the CRS mode (i.e., the subnetworks 621, 622, 623, 624), the BS 610 configures reference signals to these subnetworks to enable measurements of the interferences from each CRS subnetwork and the aggregated interference from the DRS subnetworks per subband. These subnetworks report the interference measurements to the BS 610. The BS 610 further performs the centralized subband selection/allocation and then indicates to these subnetworks of the selected subbands. All these transmissions are through transmission link 612 as shown in the FIG. 6A. All the subnetworks in the CRS mode switch to the allocated subbands simultaneously from the time instant 661 as shown in FIG. 6B, which is the first TX cycle of the CRS period (i.e., the TX cycle corresponding to the configured CRS offset). The subnetworks in the DRS mode (i.e., the subnetworks 625, 626, 627, 628, 629) performs the channel sensing within the sensing window based on the allocated or selected sensing offset and then perform the subband selection and switching.

FIG. 6B illustrates example parameters for the example scenario 600 of FIG. 6B.

In the example, it is assumed that the DRS period is 20 ms, including the sensing window 671 with duration of 12 ms and non-sensing window 672 with duration of 8 ms. During the non-sensing window 672 of the last DRS period 670-0 before the Nth CRS period 660, the CRS subnetworks (i.e., the subnetwork 621, 622, 623, 624) performs the interference measurements and reporting and the BS 610 performs the centralized subband selection for the CRS subnetworks which will use the allocated subbands from the beginning of the Nth CRS period 660 (i.e., from the m-th TX cycle as shown in FIG. 6B). In this example, it is assumed that the sensing window consists of 40 sensing offsets and each sensing offset corresponds to 3 contiguous TX cycles. It is assumed that the distributed sensing and subband selection and indication to the APs via signaling are performed within the 3 TX cycles. For the DRS subnetworks in the coverage of the network 601, the BS 610 allocates the sensing offsets based on the SCQ and/or SAI of these DRS subnetworks. In the example shown in FIG. 6B, the subnetwork 625 is allocated with the sensing offset of 0, since this subnetwork suffers more potential interference than the other DRS subnetworks. The subnetwork 626 and 627 are allocated with the sensing offsets of 2 and 1, respectively. For the subnetworks out of the coverage of the network 601 (i.e., the subnetworks 628, 629), based on the received DRS parameter, these subnetworks select the sensing offsets for distributed sensing and subband selection. In this example, the sensing offsets selected by the subnetworks 628, 629 are 10 and 11, respectively.

An example of the subband selection for all the subnetworks shown in FIG. 6A is provided in Table 1. The first column shows the subnetwork index and the subband (SB) that is being used by the subnetwork before the start of a new CRS period. As shown, the indices for the subnetworks 621, 622, 623, 624, 625, 626, 627 are SNW1, SNW2, SNW3, SNW4, SNW5, SNW6 and SNW7, respectively. As shown in Table 1, from sensing offset 0, the CRS subnetwork 621, 622, 623, 624 just keep using their original subbands. That is, according to the results of the centralized subband selection, the CRS subnetworks don't need to perform subband switching. For the subnetwork 625, as it is allocated with the sensing offset 0, it performs the channel sensing and subband selection within the TX cycles corresponding to the sensing offset 0 and based on the subband selection result, it continues to use the subband 5 (SB5) from the TX cycles corresponding to the sensing offset 1. Similarly, the subnetwork 627 performs the channel sensing and subband selection within the TX cycles corresponding to the sensing offset 1. As the subnetwork 625 is moving near, subnetwork-7, which was using in this example SB5, needs to select a different subband, in this example SB1, and switches to SB1 from the TX cycles corresponding to the sensing offset 2. Other subnetworks performs the operations similarly and are not described in details here.

TABLE 1
Example of subband selection and switching

| Sensing offset | 0 | 1 | 2 | 3 | . . . | 10 | 11 | 12 |
|---|---|---|---|---|---|---|---|---|
| SNW1 | SB1 | | | | . . . | | | |
| (SB1) | | | | | | | | |
| SNW2 | SB2 | | | | | | | |
| (SB2) | | | | | | | | |
| SNW3 | SB3 | | | | | | | |
| (SB3) | | | | | | | | |
| SNW4 | SB4 | | | | | | | |
| (SB4) | | | | | | | | |
| SNW5 | Sensing | SB5 | | | | | | |
| (SB5) | & SB- | | | | | | | |
| | select | | | | | | | |
| SNW6 | | | Sensing | SB3 | | | | |
| (SB3) | | | & SB- | | | | | |
| | | | selec. | | | | | |
| SNW7 | | Sensing | SB1 | | | | | |
| (SB5) | | & SB- | | | | | | |
| | | selec. | | | | | | |
| SNW8 | | | | | | Sensing | SB2 | |
| (SB2) | | | | | | & SB- | | |
| | | | | | | select. | | |
| SNW9 | | | | | | | Sensing | SB5 |
| (SB1) | | | | | | | & SB- | |
| | | | | | | | select. | |

### Example Methods

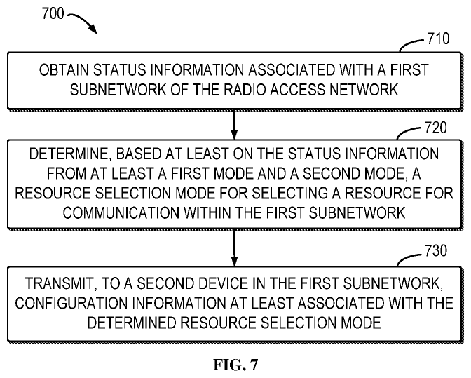

FIG. 7 shows a flowchart of an example method 700 implemented at a first device in accordance with some example embodiments of the present disclosure. For the purpose of discussion, the method 700 will be described from the perspective of the first device 110 in the radio access network 101 in FIG. 1.

At block 710, the first device 110 obtains status information associated with a first subnetwork 102 of the radio access network 101. At block 720, the first device 110 determines, based at least on the status information from at least a first mode and a second mode, a resource selection mode for selecting a resource for communication within the first subnetwork 102. At block 730, the first device 110 transmits, to a second device 120 in the first subnetwork 102, configuration information at least associated with the determined resource selection mode.

In some example embodiments, the first device 110 is caused to perform: receiving, from the second device 120, the status information associated with the first subnetwork 102.

In some example embodiments, the first device 110 selects the resource for the communication within the first subnetwork 102 when the first mode is determined as the resource selection mode, and the first device 110 indicates the second device 120 to select the resource for the communication within the first subnetwork 102 when the second mode is determined as the resource selection mode.

In some example embodiments, the status information is indicative of least one of: a channel quality of the first subnetwork 102, an interference level sensed within the first subnetwork 102, or a mobility status associated with the first subnetwork 102.

In some example embodiments, the first device 110 is caused to perform: determining, whether at least one of the following criteria is met: the channel quality of the first subnetwork 102 exceeds a first threshold and/or the interference level sensed within the first subnetwork 102 is less than a second threshold, or the mobility status of the first subnetwork 102 indicates a fast moving status; if at least one of the criteria is met, determining the second mode as the resource selection mode; and if neither of the criteria is met, determining the first mode as the resource selection mode.

In some example embodiments, the configuration information comprises at least one of: a first parameter associated with the first mode or a second parameter associated with the second mode. The first parameter comprises at least one of: a duration of a first period associated with the first mode during which the first device 110 selects the resource for the communication within the first subnetwork 102, or a starting offset indicative of when the first period starts. The second parameter comprising at least one of: a duration of a second period associated with the second mode during which the second device 120 selects the resource for the communication within the first subnetwork 102 based on a channel sensing, or a duration of a sensing window within the second period during which the channel sensing is performed.

In some example embodiments, the duration of the first period is an integer multiple of the duration of the second period.

In some example embodiments, the second mode is determined as the resource selection mode and the first device 110 is further caused to perform: determining, based at least on the status information, a sensing offset within the sensing window, the sensing offset indicating a starting time when the channel sensing is performed within the sensing window; and transmitting, to the second device 120, an indication indicative of the sensing offset.

In some example embodiments, the channel sensing is performed by the second device 120 or a terminal device in the first subnetwork 102.

In some example embodiments, the first mode is determined for the first subnetwork 102 and the first device 110 is further caused to perform: transmitting, to the second device 120, measurement configuration information associated with an interference measurement performed within the first subnetwork 102; receiving, from the second device 120, a measurement report associated with the interference measurement; selecting the resource for the communication within the first subnetwork 102 based at least on the measurement report; and transmitting, to the second device 120, an indication indicative of the selected resource.

In some example embodiments, the measurement report is indicative of at least one of: an interference from a subnetwork in which the first mode is determined as the resource selection mode, or an interference over a frequency subband. The interference over the frequency band includes interference from other subnetworks in the second mode but does not include the interference from other subnetworks in the first mod.

In some example embodiments, the first device 110 is further caused to perform: transmitting, to the second device 120, a request to transmit the second parameter associated with the second mode to a third device 130 in a second subnetwork 103 outside the radio access network 101.

In some example embodiments, the first device 110 comprises a base station, the second device 120 comprises an access point and the third device 130 comprises an access point.

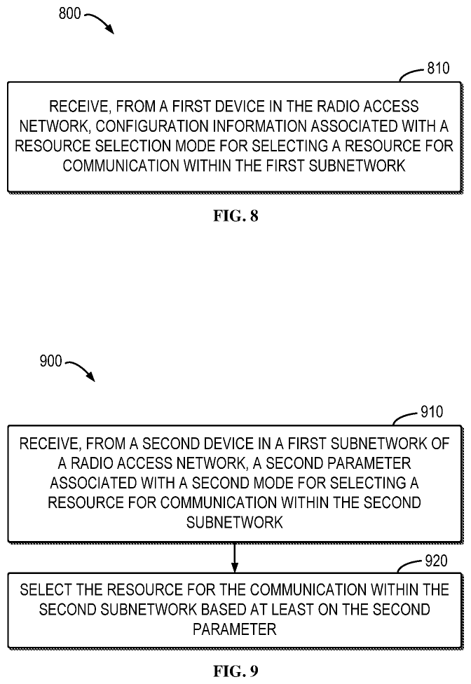

FIG. 8 shows a flowchart of an example method 800 implemented at a second device 120 in accordance with some example embodiments of the present disclosure. For the purpose of discussion, the method 800 will be described from the perspective of the second device 120 in a first subnetwork 102 in FIG. 1.

At block 810, the second device 120 receives, from a first device 110 in the radio access network 101, configuration information associated with a resource selection mode for selecting a resource for communication within the first subnetwork 102, wherein the resource selection mode is at least one of a first mode and a second mode.

In some example embodiments, the second device 120 is caused to perform: transmitting to the first device 110, the status information associated with the first subnetwork 102.

In some example embodiments, the first device 110 selects the resource for the communication within the first subnetwork 102 when the first mode is determined as the resource selection mode, and the first device 110 indicates the second device 120 to select the resource for the communication within the first subnetwork 102 when the second mode is determined as the resource selection mode.

In some example embodiments, the status information is indicative of least one of: a channel quality of the first subnetwork 102, an interference level sensed within the first subnetwork 102, or a mobility status associated with the first subnetwork 102.

In some example embodiments, the configuration information comprises at least one of: a first parameter associated with the first mode or a second parameter associated with the second mode. The first parameter comprises at least one of: a duration of a first period associated with the first mode during which the first device 110 selects the resource for the communication within the first subnetwork 102, or a starting offset indicative of when the first period starts. The second parameter comprising at least one of: a duration of a second period associated with the second mode during which the second device 120 selects the resource for the communication within the first subnetwork 102 based on a channel sensing, or a duration of a sensing window within the second period during which the channel sensing is performed.

In some example embodiments, the duration of the first period is an integer multiple of the duration of the second period.

In some example embodiments, the second mode is determined as the resource selection mode and the second device 120 is further caused to perform: receiving from the first device 110, an indication indicative of a sensing offset for the second device 120, the sensing offset indicating a starting time within the sensing window when the channel sensing is performed; performing the channel sensing and/or requesting a terminal device in the first subnetwork 102 to perform the channel sensing based on the sensing window and the sensing offset; and selecting the resource for the communication within the first subnetwork 102 based on the channel sensing.

In some example embodiments, the first mode is determined as the resource selection mode and the second device 120 is further caused to perform: receiving, from the first device 110, measurement configuration information associated with an interference measurement performed within the first subnetwork 102; performing the interference measurement and/or requesting a terminal device within the first subnetwork 102 to perform the interference measurement based on the measurement configuration information associated with an interference measurement; transmitting, to the first device 110, a measurement report associated with the interference measurement; receiving, from the first device 110, an indication indicative of the resource for the communication within the first subnetwork 102; and performing the communication within the first subnetwork 102 using the resource in the first period starting from the starting offset.

In some example embodiments, the measurement report is indicative of at least one of: an interference from a subnetwork in which the first mode is determined as the resource selection mode, or an interference over a frequency subband. The interference over the frequency band includes interference from other subnetworks in the second mode but does not include the interference from other subnetworks in the first mod.

In some example embodiments, the second device 120 is further caused to perform: receiving, from the first device 110, a request to transmit the second parameter associated with the second mode to a third device 130 in a second subnetwork 103 outside the radio access network 101; and transmitting to the third device 130, the second parameter associated with the second mode.

In some example embodiments, the first device 110 comprises a base station, the second device 120 comprises an access point and the third device 130 comprises an access point.

FIG. 9 shows a flowchart of an example method 900 implemented at a third device 130 in accordance with some example embodiments of the present disclosure. For the purpose of discussion, the method 900 will be described from the perspective of the third device 130 in a second subnetwork 103 in FIG. 1.

At block 910, the third device 130 receives, from a second device 120 in a first subnetwork 102 of a radio access network 101, a second parameter associated with a second mode for selecting a resource for communication within the second subnetwork 103, wherein the second subnetwork 103 is outside the radio access network 101. At block 920, the third device 130 selects the resource for the communication within the second subnetwork 103 based at least on the second parameter.

In some example embodiments, the second parameter comprises at least one of: a duration of a second period associated with the second mode during which the third device 130 selects the resource for the communication within the second subnetwork 103 based on a channel sensing, or a duration of a sensing window within the second period during which the channel sensing is performed.

In some example embodiments, the third device 130 is further caused to perform: determining a sensing offset based at least on the second parameter, the sensing offset indicating a starting time within the sensing window when the channel sensing is performed; performing the channel sensing and/or requesting a terminal device in the second subnetwork 103 to perform the channel sensing based on the sensing window and the sensing offset; and selecting the resource for the communication within the second subnetwork 103 based on the channel sensing.

### Example Apparatus, Device and Medium

In some example embodiments, a first apparatus capable of performing any of the method 700 (for example, the first device 110 in FIG. 1) may comprise means for performing the respective operations of the method 700. The means may be implemented in any suitable form. For example, the means may be implemented in a circuitry or software module. The first apparatus may be implemented as or included in the first device 110 in FIG. 1.

In some example embodiments, the first apparatus in a radio access network comprises means for obtaining status information associated with a first subnetwork of the radio access network; means for determining, based at least on the status information from at least a first mode and a second mode, a resource selection mode for selecting a resource for communication within the first subnetwork; and means for transmitting, to a second apparatus in the first subnetwork, configuration information at least associated with the determined resource selection mode.

In some example embodiments, the means for obtaining status information comprises: means for receiving, from the second apparatus, the status information associated with the first subnetwork.

In some example embodiments, the first apparatus selects the resource for the communication within the first subnetwork when the first mode is determined as the resource selection mode, and the first apparatus indicates the second apparatus to select the resource for the communication within the first subnetwork when the second mode is determined as the resource selection mode.

In some example embodiments, the status information is indicative of least one of: a channel quality of the first subnetwork, an interference level sensed within the first subnetwork, or a mobility status associated with the first subnetwork.

In some example embodiments, the means for determining comprises: means for determining, whether at least one of the following criteria is met: the channel quality of the first subnetwork exceeds a first threshold and/or the interference level sensed within the first subnetwork is less than a second threshold, or the mobility status of the first subnetwork indicates a fast moving status; means for if at least one of the criteria is met, determining the second mode as the resource selection mode; and means for if neither of the criteria is met, determining the first mode as the resource selection mode.

In some example embodiments, the configuration information comprises at least one of: a first parameter associated with the first mode or a second parameter associated with the second mode. The first parameter comprises at least one of: a duration of a first period associated with the first mode during which the first apparatus selects the resource for the communication within the first subnetwork, or a starting offset indicative of when the first period starts. The second parameter comprising at least one of: a duration of a second period associated with the second mode during which the second apparatus selects the resource for the communication within the first subnetwork based on a channel sensing, or a duration of a sensing window within the second period during which the channel sensing is performed.

In some example embodiments, the duration of the first period is an integer multiple of the duration of the second period.

In some example embodiments, the second mode is determined as the resource selection mode and the first apparatus further comprises: means for determining, based at least on the status information, a sensing offset within the sensing window, the sensing offset indicating a starting time when the channel sensing is performed within the sensing window; and means for transmitting, to the second apparatus, an indication indicative of the sensing offset.

In some example embodiments, the channel sensing is performed by the second apparatus or a terminal device in the first subnetwork.

In some example embodiments, the first mode is determined for the first subnetwork and the first apparatus further comprises: means for transmitting, to the second apparatus, measurement configuration information associated with an interference measurement performed within the first subnetwork; means for receiving, from the second apparatus, a measurement report associated with the interference measurement; means for selecting the resource for the communication within the first subnetwork based at least on the measurement report; and means for transmitting, to the second apparatus, an indication indicative of the selected resource.

In some example embodiments, the measurement report is indicative of at least one of: an interference from a subnetwork in which the first mode is determined as the resource selection mode, or an interference over a frequency subband. The interference over the frequency band includes interference from other subnetworks in the second mode but does not include the interference from other subnetworks in the first mod.

In some example embodiments, the first apparatus further comprises: means for transmitting, to the second apparatus, a request to transmit the second parameter associated with the second mode to a third apparatus in a second subnetwork outside the radio access network.

In some example embodiments, the first apparatus comprises a base station, the second apparatus comprises an access point and the third apparatus comprises an access point.

In some example embodiments, the first apparatus further comprises means for performing other operations in some example embodiments of the method 700 or the first device 110. In some example embodiments, the means comprises at least one processor; and at least one memory storing instructions that, when executed by the at least one processor, cause the performance of the first apparatus.

In some example embodiments, a second apparatus capable of performing any of the method 800 (for example, the second device 120 in FIG. 1) may comprise means for performing the respective operations of the method 800. The means may be implemented in any suitable form. For example, the means may be implemented in a circuitry or software module. The second apparatus may be implemented as or included in the second device 120 in FIG. 1.

In some example embodiments, the second apparatus in a first subnetwork of a radio access network comprises: means for receiving, from a first apparatus in the radio access network, configuration information associated with a resource selection mode for selecting a resource for communication within the first subnetwork, wherein the resource selection mode is at least one of a first mode and a second mode

In some example embodiments, the second apparatus comprises: means for transmitting, to the first apparatus, the status information associated with the first subnetwork.

In some example embodiments, the first apparatus selects the resource for the communication within the first subnetwork when the first mode is determined as the resource selection mode, and the first apparatus indicates the second apparatus to select the resource for the communication within the first subnetwork when the second mode is determined as the resource selection mode.

In some example embodiments, the status information is indicative of least one of: a channel quality of the first subnetwork, an interference level sensed within the first subnetwork, or a mobility status associated with the first subnetwork.

In some example embodiments, the configuration information comprises at least one of: a first parameter associated with the first mode or a second parameter associated with the second mode. The first parameter comprises at least one of: a duration of a first period associated with the first mode during which the first apparatus selects the resource for the communication within the first subnetwork, or a starting offset indicative of when the first period starts. The second parameter comprising at least one of: a duration of a second period associated with the second mode during which the second apparatus selects the resource for the communication within the first subnetwork based on a channel sensing, or a duration of a sensing window within the second period during which the channel sensing is performed.

In some example embodiments, the duration of the first period is an integer multiple of the duration of the second period.

In some example embodiments, the second mode is determined as the resource selection mode and the second apparatus further comprises: means for receiving from the first apparatus, an indication indicative of a sensing offset for the second apparatus, the sensing offset indicating a starting time within the sensing window when the channel sensing is performed; means for performing the channel sensing and/or requesting a terminal apparatus in the first subnetwork to perform the channel sensing based on the sensing window and the sensing offset; and means for selecting the resource for the communication within the first subnetwork based on the channel sensing.

In some example embodiments, the first mode is determined as the resource selection mode and the second apparatus further comprises: means for receiving, from the first apparatus, measurement configuration information associated with an interference measurement performed within the first subnetwork; means for performing the interference measurement and/or requesting a terminal apparatus within the first subnetwork to perform the interference measurement based on the measurement configuration information associated with an interference measurement; means for transmitting, to the first apparatus, a measurement report associated with the interference measurement; means for receiving, from the first apparatus, an indication indicative of the resource for the communication within the first subnetwork; and means for performing the communication within the first subnetwork using the resource in the first period starting from the starting offset.

In some example embodiments, the measurement report is indicative of at least one of: an interference from a subnetwork in which the first mode is determined as the resource selection mode, or an interference over a frequency subband. The interference over the frequency band includes interference from other subnetworks in the second mode but does not include the interference from other subnetworks in the first mod.

In some example embodiments, the second apparatus further comprises: means for receiving, from the first apparatus, a request to transmit the second parameter associated with the second mode to a third apparatus in a second subnetwork outside the radio access network; and means for transmitting to the third apparatus, the second parameter associated with the second mode.

In some example embodiments, the first apparatus comprises a base station, the second apparatus comprises an access point and the third apparatus comprises an access point.

In some example embodiments, the second apparatus further comprises means for performing other operations in some example embodiments of the method 800 or the second device 120. In some example embodiments, the means comprises at least one processor; and at least one memory storing instructions that, when executed by the at least one processor, cause the performance of the second apparatus.

In some example embodiments, a third apparatus capable of performing any of the method 900 (for example, the third device 130 in FIG. 1) may comprise means for performing the respective operations of the method 900. The means may be implemented in any suitable form. For example, the means may be implemented in a circuitry or software module. The third apparatus may be implemented as or included in the third device 130 in FIG. 1.

In some example embodiments, the third apparatus in a second subnetwork comprises means for receiving, at a third apparatus in a second subnetwork and from a second apparatus in a first subnetwork of a radio access network, a second parameter associated with a second mode for selecting a resource for communication within the second subnetwork, wherein the second subnetwork is outside the radio access network; and means for selecting the resource for the communication within the second subnetwork based at least on the second parameter.

In some example embodiments, the second parameter comprises at least one of: a duration of a second period associated with the second mode during which the third apparatus selects the resource for the communication within the second subnetwork based on a channel sensing, or a duration of a sensing window within the second period during which the channel sensing is performed.

In some example embodiments, the means for selecting the resource comprises: means for determining a sensing offset based at least on the second parameter, the sensing offset indicating a starting time within the sensing window when the channel sensing is performed; means for performing the channel sensing and/or requesting a terminal apparatus in the second subnetwork to perform the channel sensing based on the sensing window and the sensing offset; and means for selecting the resource for the communication within the second subnetwork based on the channel sensing.

In some example embodiments, the third apparatus further comprises means for performing other operations in some example embodiments of the method 900 or the third device 130. In some example embodiments, the means comprises at least one processor; and at least one memory storing instructions that, when executed by the at least one processor, cause the performance of the third apparatus.

FIG. 10 is a simplified block diagram of a device 1000 that is suitable for implementing example embodiments of the present disclosure. The device 1000 may be provided to implement a communication device, for example, the first device 110 or the second device 120 or the third device 130 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements.

In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 2, FIG. 4, FIG. 5, FIG. 7 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution.

In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

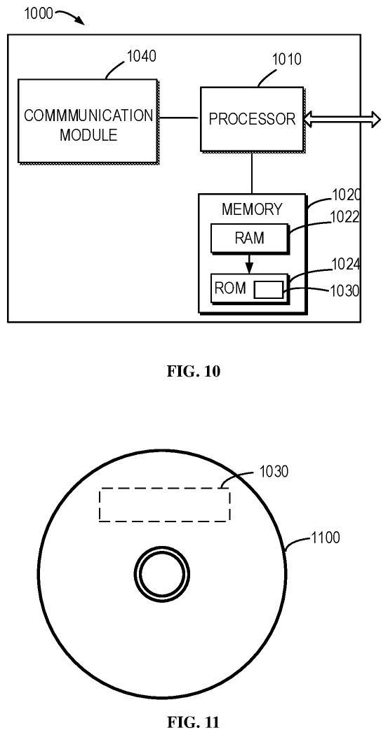

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results.

In certain circumstances, multitasking and parallel processing may be advantageous.

Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-34. (canceled)

35. A first device in a radio access network, comprising:
at least one processor; and
at least one memory storing instructions that, when executed by the at least one processor, cause the first device at least to perform:
obtaining status information associated with a first subnetwork of the radio access network wherein the status information is indicative of: a channel quality of the first subnetwork, an interference level sensed within the first subnetwork, and a mobility status associated with the first subnetwork;
determining, whether the following criteria is met:
the channel quality of the first subnetwork exceeds a first threshold and the interference level sensed within the first subnetwork is less than a second threshold, and
the mobility status of the first subnetwork indicates a fast moving status;
based on determining none of the criteria is met, determining a first mode as a resource selection mode and not a second mode;
transmitting, to a second device in the first subnetwork, configuration information at least associated with the determined resource selection mode, wherein the configuration information comprises a first parameter associated with the first mode, the first parameter comprising:
a duration of a first period associated with the first mode during which the first device selects the resource for communication within the first subnetwork, and
a starting offset indicative of when the first period starts;
determining, based at least on the status information, a sensing offset within the sensing window, the sensing offset indicating a starting time when channel sensing is performed within the sensing window;
transmitting, to the second device, a first indication indicative of the sensing offset;
transmitting, to the second device, measurement configuration information associated with an interference measurement performed within the first subnetwork;
receiving, from the second device, a measurement report associated with the interference measurement, wherein the measurement report is indicative of: an interference from a subnetwork in which the first mode is determined as the resource selection mode, and an interference over a frequency subband, wherein the frequency subband is the resource for communications within a subnetwork and not used in a subnetwork in which the first mode is determined as the resource selection mode;
selecting the resource for the communication within the first subnetwork based at least on the measurement report; and
transmitting, to the second device, a second indication indicative of the selected resource.

36. The first device of claim 35, wherein the first device is caused to perform:
receiving, from the second device, the status information associated with the first subnetwork.

37. The first device of claim 36, wherein the first device selects the resource for the communication within the first subnetwork when the first mode is determined as the resource selection mode.

38. The first device of claim 36, wherein the first device is caused to perform: determining a second mode as a resource selection mode if at least one of the criteria is met.

39. The first device of claim 38, wherein the first device is caused to perform: indicating the second device to select the resource for the communication within the first subnetwork when the second mode is determined as the resource selection mode.

40. The first device of claim 39, wherein the channel sensing is performed by the second device or a terminal device in the first subnetwork.

41. The first device of claim 40, wherein the first device comprises a base station and the second device comprises an access point.

42. A system comprising:
a first device in a radio access network;
at least one processor; and
at least one memory storing instructions that, when executed by the at least one processor, cause the first device at least to perform:
obtaining status information associated with a first subnetwork of the radio access network wherein the status information is indicative of: a channel quality of the first subnetwork, an interference level sensed within the first subnetwork, and a mobility status associated with the first subnetwork;
determining, whether the following criteria is met:
the channel quality of the first subnetwork exceeds a first threshold and the interference level sensed within the first subnetwork is less than a second threshold, and
the mobility status of the first subnetwork indicates a fast moving status;
based on determining none of the criteria is met, determining a first mode as a resource selection mode and not a second mode;
transmitting, to a second device in the first subnetwork, configuration information at least associated with the determined resource selection mode, wherein the configuration information comprises a first parameter associated with the first mode, the first parameter comprising:
a duration of a first period associated with the first mode during which the first device selects the resource for communication within the first subnetwork, and
a starting offset indicative of when the first period starts;
determining, based at least on the status information, a sensing offset within the sensing window, the sensing offset indicating a starting time when channel sensing is performed within the sensing window;
transmitting, to the second device, a first indication indicative of the sensing offset;
transmitting, to the second device, measurement configuration information associated with an interference measurement performed within the first subnetwork;
receiving, from the second device, a measurement report associated with the interference measurement, wherein the measurement report is indicative of: an interference from a subnetwork in which the first mode is determined as the resource selection mode, and an interference over a frequency subband, wherein the frequency subband is the resource for communications within a subnetwork and not used in a subnetwork in which the first mode is determined as the resource selection mode;
selecting the resource for the communication within the first subnetwork based at least on the measurement report; and
transmitting, to the second device, a second indication indicative of the selected resource.

43. The system of claim 42, wherein the first device is caused to perform:
receiving, from the second device, the status information associated with the first subnetwork.

44. The system of claim 43, wherein the first device selects the resource for the communication within the first subnetwork when the first mode is determined as the resource selection mode.

45. The system of claim 42, wherein the first device is caused to perform: determining a second mode as a resource selection mode if at least one of the criteria is met.

46. The system of claim 45, wherein the first device is caused to perform: indicating the second device to select the resource for the communication within the first subnetwork when the second mode is determined as the resource selection mode.

47. The system of claim 42, wherein the channel sensing is performed by the second device or a terminal device in the first subnetwork.

48. The system of claim 47, wherein the first device comprises a base station and the second device comprises an access point.

49. A method comprising:
obtaining, by a first device, status information associated with a first subnetwork of the radio access network wherein the status information is indicative of: a channel quality of the first subnetwork, an interference level sensed within the first subnetwork, and a mobility status associated with the first subnetwork;
determining, whether the following criteria is met:
the channel quality of the first subnetwork exceeds a first threshold and the interference level sensed within the first subnetwork is less than a second threshold, and
the mobility status of the first subnetwork indicates a fast moving status;
based on determining none of the criteria is met, determining a first mode as a resource selection mode and not a second mode;
transmitting, to a second device in the first subnetwork, configuration information at least associated with the determined resource selection mode, wherein the configuration information comprises a first parameter associated with the first mode, the first parameter comprising:
a duration of a first period associated with the first mode during which the first device selects the resource for communication within the first subnetwork, and
a starting offset indicative of when the first period starts;
determining, by the first device based at least on the status information, a sensing offset within the sensing window, the sensing offset indicating a starting time when channel sensing is performed within the sensing window;
transmitting, to the second device, a first indication indicative of the sensing offset;
transmitting, to the second device, measurement configuration information associated with an interference measurement performed within the first subnetwork;
receiving, from the second device, a measurement report associated with the interference measurement, wherein the measurement report is indicative of: an interference from a subnetwork in which the first mode is determined as the resource selection mode, and an interference over a frequency subband, wherein the frequency subband is the resource for communications within a subnetwork and not used in a subnetwork in which the first mode is determined as the resource selection mode;
selecting, by the first device, the resource for the communication within the first subnetwork based at least on the measurement report; and
transmitting, to the second device, a second indication indicative of the selected resource.

50. The method of claim 49, further comprising: receiving, from the second device, the status information associated with the first subnetwork.

51. The method of claim 50, wherein the first device selects the resource for the communication within the first subnetwork when the first mode is determined as the resource selection mode.

52. The method of claim 51, wherein the channel sensing is performed by the second device or a terminal device in the first subnetwork.

53. The method of claim 52, wherein the first device is a base station and the second device is an access point.
